(19) United States
(12) Patent Application Publication
(10) Pub. No.: US 2003/0145096 A1
(43) Pub. Date: Jul. 31, 2003

(54) Method and device for delivering information through a distributed information system

(75) Inventors: Gerd Breiter, Wildberg (DE); Harald Daur, Esslingen (DE); Frank W. Kunze, Bietigheim-Bissingen (DE)

Correspondence Address: IBM Corporation, IPLaw Department, 2455 South Road - M/S P386, Poughkeepsie, NY, 12601, US

(73) Assignee: International Business Machines Corporation, Armonk, NY (US)

(21) Appl. No.: 10/334,328

(22) Filed: Dec. 31, 2002

(30) Foreign Application Priority Data
Jan. 29, 2002 (DE) 02002157.2

(51) Int. Cl. G06F 15/173; G06F 15/16

(52) U.S. Cl. 709/231; 709/223

(57) ABSTRACT

According to the present invention a device, also called appliance or streaming appliance, and a method for operating the device is provided. The device is prepared for delivering information through a distributed information system to an external client unit in response to a request from an external server unit. A first interface, e.g., a system administration Web service interface, allows configuring and administering the device and a device control unit facilitates controlling the device, whereby the device control unit is configured to register the device with an external service directory via the first interface. Advantageously, the device only needs to be connected to a respective distributed information system, such as the Internet, and it automatically starts offering its services within such information system.

### BACKGROUND OF THE INVENTION

1. Field of the Invention

The present invention generally relates to a method and device for delivering information through a distributed information system. Particularly, the present invention relates to a device for delivering information through a distributed information system to an external client unit in response to a request from an external server unit and a method therefor.

2. Description of the Related Art

The Web, short for World Wide Web (WWW), and often synonymously used for the Internet or any other distributed information system, has evolved to become a more and more important communication channel in business and private action for offering and accessing digital content. In this context ‘content’ may be seen as an abundant amount of well-presented subject information organized for interesting and useful access in a hypertext structure.

At the same time, Web-based content is becoming more complex by incorporating new types of content. Beside the commonly used textual pages with graphics and images, rich media are becoming more and more used. The expression ‘Rich media’ refers to Web page using advanced technology such as streaming video or downloaded applets (programs) that interact instantly with the user. Rich media data extends traditional computer data formats into more natural data formats for the interaction of humans and computers by incorporating motion pictures, voice, audio, and video. Leading market, business, social, and technical indicators point to the growing importance of this kind of digitally recorded content.

It can be seen that rich media data is getting more and more common and pervasive in Internet applications. Although Internet applications that present different kinds of digital content, e.g., textual pages or rich media, have different requirements and use cases, they all work with similar content data. However, Internet applications presenting rich media are becoming very complex and not easily customizable to individual requirements.

One of the key problems with rich media data is transferring the huge amount of data through a network. Normally, data is transferred using the store-and-forward paradigm, i.e. the complete content is transferred before the data can be accessed. A well-known implementation of this paradigm is the File Transfer Protocol (FTP), the standard way to transfer files throughout the World Wide Web. For conventional data this works fine, as the amounts of data to be transferred are comparably small. For audio and video clips, though, the latency time that passes between a request for rendering and the start of the rendering become impractically long.

In recent years another paradigm called streaming has emerged. Streaming allows the rendering of the media to take place in parallel with the transfer of its content, which reduces latency times to a minimum. Streaming software always comes in pairs, a stream server pumping the data continuously through the network and a player receiving the data and rendering it.

A streaming connection will always be requested by the player. While establishing such a data connection the player uses information provided with so called metadata to connect to the stream server and request the streaming of the specified media. At least the address of the stream server and a key that identifies the media is part of the metadata. That key is used by the stream server to find the requested media within its cache. Further information like access tickets, bandwidth information, offsets within the media etc. may also be part of the metadata.

In order to ensure the quality of the data stream, which in general means that the required bandwidth could be written to the network throughout the entire stream duration, current stream servers require the rich media data object to reside on its local file system. So every stream server which is required to stream a rich media data object has to keep a copy within its local disk cache.

A typical architecture for Internet applications using streaming of rich media consists of several servers. In addition to the well known Web server, several other components are required which make up a very complex infrastructure. For example, to get acceptable media streaming services a huge amount of distributed servers such as edge servers are necessary to enable short access latency time. Worldwide accessible Internet applications therefore need a worldwide distributed set of edge servers, close to the clients.

Setup, operation and maintenance of such an infrastructure with “24/7” (i.e., continuous) availability and a well-defined quality of service are very complex and expensive and need highly skilled operation personal. In some of the business models this creates unacceptable expenses for the Internet application providers and/or the application users.

### SUMMARY OF THE INVENTION

Starting from this, an object of the present invention is to provide a method and system which enables companies to build up a streaming network having a reduced complexity and cost compared to known solutions.

The foregoing object is achieved by a method and a system as laid out in the independent claims. Further advantageous embodiments of the present invention are described in the subclaims and are taught in the following description.

According to the present invention a device, also referred to as an ‘appliance’ or ‘streaming appliance’, and a method for operating the device is provided. The device is prepared for delivering information through a distributed information system to an external client unit in response to a request from an external server unit. A first interface, e.g., a system administration Web service interface, allows configuring and administering the device and a device control unit facilitates controlling the device, whereby the device control unit is configured to register the device with an external service directory via the first interface. Advantageously, the device only needs to be connected to a distributed information system, such as the Internet, and it automatically starts offering its services within such information system.

In order to perform the offered service the device according to the present invention further comprises one or more data servers, e.g., steaming servers, for delivering requested information, a second interface, e.g., a streaming Web service interface, for communicating with the external server unit, and a third interface, e.g., a streaming interface, for communicating with the external client unit, whereby the device control unit is configured to receive a request from the external server unit via the second interface to arrange information delivery to an external client via the third interface.

The device and method according to the present invention is suitable for easily establishing a streaming network. The devices, or appliances, according to the present invention only need to be incorporated into a network. Advantageously, the communication with the appliance is based on the Web service standard. This may even extend the usability of the present invention.

Also the present invention may be used with all different kind of information, it may in particular be suitable for dealing with rich media. As is known, rich media are more and more used by Internet applications. The bandwidth used by rich media is obviously greater than for small text and image data. Heavy usage of rich media with traditional Web and application server topologies may overload the network.

The appliances in accordance with the present invention may advantageously be placed at the edge of the network, close to the user. Due to their construction they hardly need any maintenance and if any, the maintenance may be done via remote access. In a preferred topology they fit in a system consisting of Web servers, application servers and content servers in the back end and function as a network of stream servers at the edge.

Building up such a stream server network using the appliance in accordance with the present invention promises to be less complicated and less expensive than doing the same with standard hardware and software components.

An implementation of a streaming network based on streaming appliances with a Web service interface advantageously abstracts over the peculiarities of the different streaming technologies and products with all their certain requirements. For example, the Internet application does not need to know the different interfaces for the individual stream server products that may be running on the appliance. Using a streaming appliance the Internet application is no longer tied to a certain type of server/player pair with their proprietary interfaces. Therefore, this invention proposes the appliance to be used in a network of streaming appliances, each accessible by the back-end servers through the Web service interface.

According to the standards of a Web service, each streaming appliance registers in a directory such as an UDDI (Universal Description, Discovery and Integration) directory. An Internet application which needs streaming services may look up the required service in the directory. Selection can be made according to stated service properties such as functionality, quality of service and cost.

The streaming appliance itself may be realized as a specialized network-based hardware device designed to perform the single specialized function of streaming rich media. It has minimum operating system (OS) presence. The access of any client is possible using the standard Web service protocol. In addition, the device is a “closed box” delivering extreme ease of installation, minimal maintenance effort and remote manageability.

The streaming appliance is operated through various well-defined interfaces. The Web service interface is used by a provider of rich media who wants to use the streaming appliance for his clients. Typically the provider sends a request for streaming via the Web service interface. The request at least contains information about the media data to be streamed, information about location and access. On return the provider gets the metadata which is required by the client to initiate the streaming. The Web service interface furthermore is used for metering and billing related services. For example, the provider of rich media can query the streaming appliance for information about the communication between stream server and client, whether the client has accessed the server, usage statistics, etc.

The system maintenance interface is used by the hoster of the streaming appliance. The appliance is configured and maintained through this interface.

The actual streaming of rich media is done through the stream server interface. This interface is stream server specific, and is implemented by the stream server product running on the appliance. A client connects to this interface to request streaming of a certain media.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a general block diagram which illustrates a system in accordance with the present invention using streaming appliances;

FIG. 2 is a block diagram showing the functional units of the streaming appliance;

FIG. 3 is a flowchart illustrating the method of adding a new streaming appliance to the system;

FIG. 4 is a flowchart illustrating a method of handling a client's streaming request; and

FIG. 5 is a general block diagram which illustrates a system in accordance with the present invention using a Streaming Broker Web service.

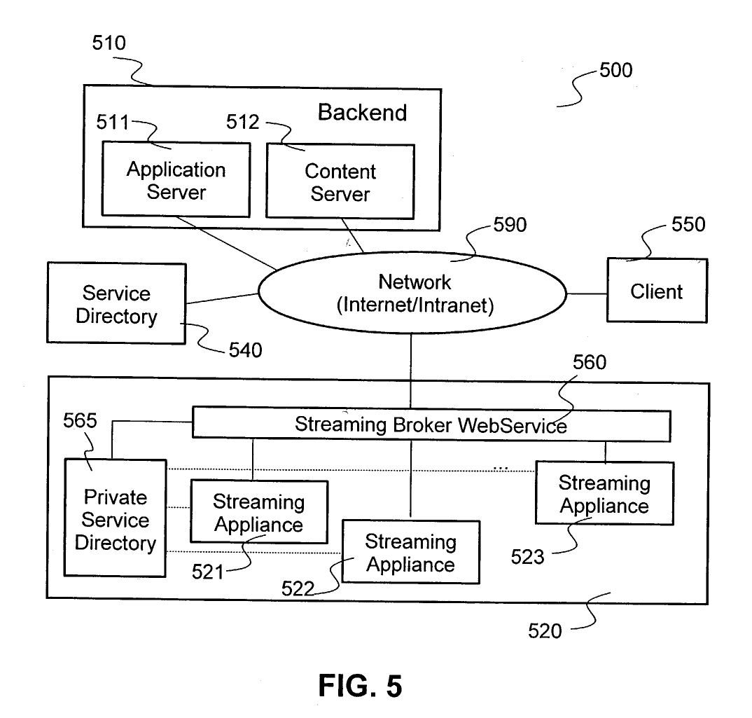

### DETAILED DESCRIPTION OF THE INVENTION

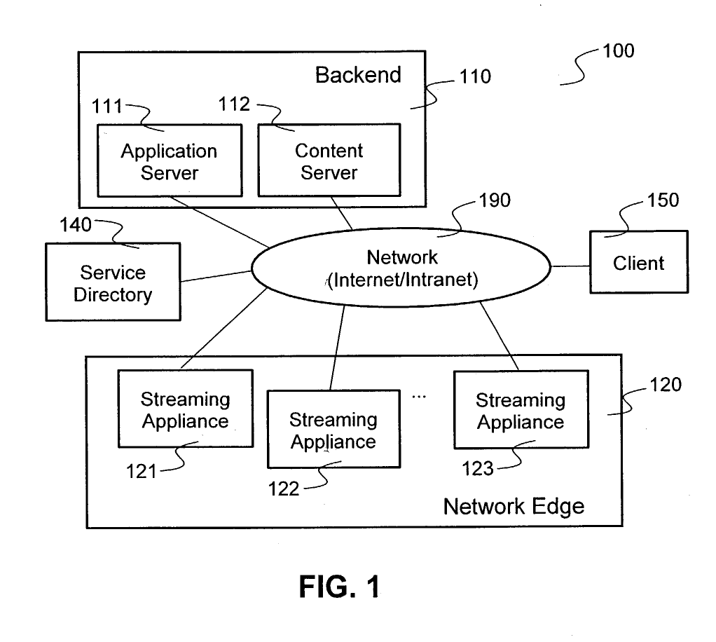

With reference now to FIG. 1, there is depicted a general block diagram which illustrates a system 100 in accordance with the present invention. The system 100 comprises an application server 111, a content server 112, both located in a back end 110, various streaming appliances 121, 122 and 123 located in a network edge 120, a service directory 140 and a client 150 which all are connected via a distributed information system represented by a network 190. The distributed information system may be formed by an intranet, i.e., any network which provides similar services within an organization to those provided by the Internet outside it but which is not necessarily connected to the Internet, and/or the Internet.

The application server 111 may be formed by a server program in a computer in a distributed information system that provides the business logic for an application program. The application server may be viewed as part of a three-tier application, consisting of a graphical user interface (GUI) server, an application (business logic) server, and a database and transaction server. More descriptively, it may be viewed as dividing an application into a first-tier, front-end, Web browser-based graphical user interface, usually at a personal computer or workstation, a middle-tier business logic application or set of applications, possibly on a local area network or intranet server, and a third-tier, back-end, database and transaction server, sometimes on a mainframe or large server.

Besides the application server 111, the content server 112 is also located in the back end 110. The application running on the application server 111 handles all incoming requests from any connected client 150, whereas the content server 112 stores the relevant content data such as the rich media objects.

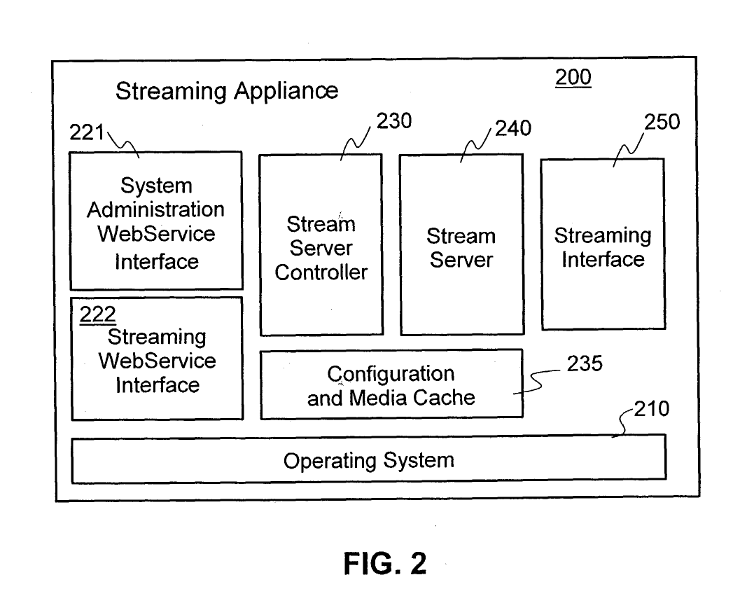

The streaming appliances 121 to 123 are described in greater detail with reference to FIG. 2 below. They are distributed at the network edge 120 close to the clients 150 in order to improve the streaming performance.

The service directory 140 acts as a mediator between the back end's servers and the streaming appliances. It may be realized as an application accessible over a distributed information system including a database unit for storing the information. Conceptually, the information provided by the service directory 140 comprise three components. A first set of information includes address information, contact information, and other identifiers known in the respective area of business. A second set of information includes industrial categorizations based on standard taxonomies, and, a third set of information includes technical information about the respective services that are exposed by the business. Furthermore, the third set of information may include references to specifications for Web services, as well as support for pointers to various file and URL (Uniform Resource Locator)-based discovery mechanisms if required.

In the present context the service directory 140 may advantageously provide a list of all available streaming services as provided by the streaming appliances. The service directory may be used for reference by any application on the application server 111 which needs streaming. The streaming service as provided by the streaming appliance is defined according to the standardized SOA (Service Oriented Architecture) model. Therefore the service directory may be any type of UDDI (Universal Description, Discovery, and Integration) standardized directory.

With reference to FIG. 2, there is depicted the functional units of a streaming appliance in accordance to the present invention as introduced above. The functional units may be implemented as a computer program product. The base for all functional units is formed by an operating system 210. The operating system may be any form of the Linux operating system, but is not limited to that.

On top of the operating system 210 a stream server 240 is running. The stream server 240 is controlled by the stream server controller component 230. As there are various stream server products available, there will also be various streaming appliance types, each with a different stream servers product. There may be even a streaming appliance utilizing a set of stream server products. The stream server controller component 230 abstracts over the various stream servers 240. Therefore various streaming appliances will not differ in the utilization, even if they contain different stream servers.

The configuration and media cache 235 is used to store all information which is necessary for operation and administration. Among the configuration data and media, all relevant data for user management and service metering is stored to allow billing for used services of the streaming appliance.

The operation of the streaming appliance is performed through the following three interfaces: the system administration Web service interface 221, the streaming Web service interface 222, and the streaming interface 250. The system administration Web service interface 221 is used for configuration tasks and system administration. It provides services for configuration and customization, user management and service metering which are necessary for billing. The streaming Web service interface 222 is used for all communication from the application server. It is used to prepare the streaming appliance for streaming of a selected media object and to provide all necessary information to the application server in order to stream. Finally the streaming interface 250 is used by the client. The client connects to the streaming appliance through this interface for the streaming of the media object.

The system administration interface 221 and the streaming Web service interface 222 are defined according to the SOA (Service Oriented Architecture) model standard. Therefore the service may be listed and/or found in a service directory, such as the UDDI (Universal Description, Discovery, and Integration). The service itself can be described using standardized WSDL (Web Services Description Language).

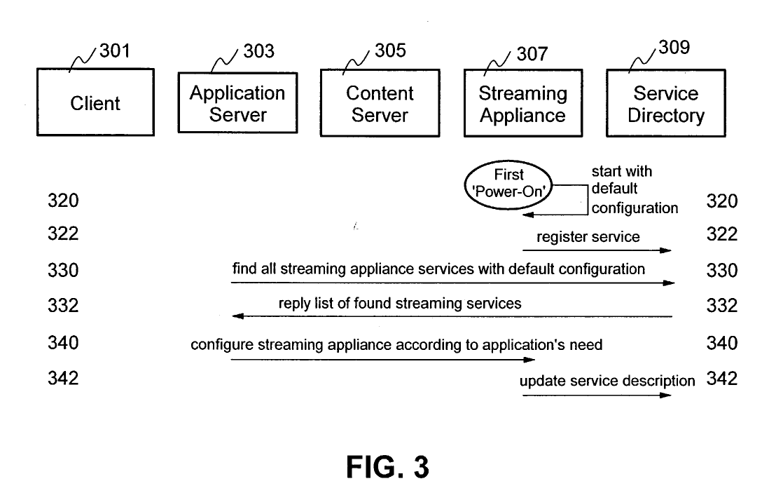

The following section details the communication between the functional units of the streaming network according to the present invention. In order to illustrate which functional units are communicating with each other, the respective functional units are depicted in the upper part of FIG. 3, namely, a client 301, an application server 303, a content server 305, a streaming appliance 307 and a service directory 309. All those components correspond to the components of the same name as described with reference to FIG. 1.

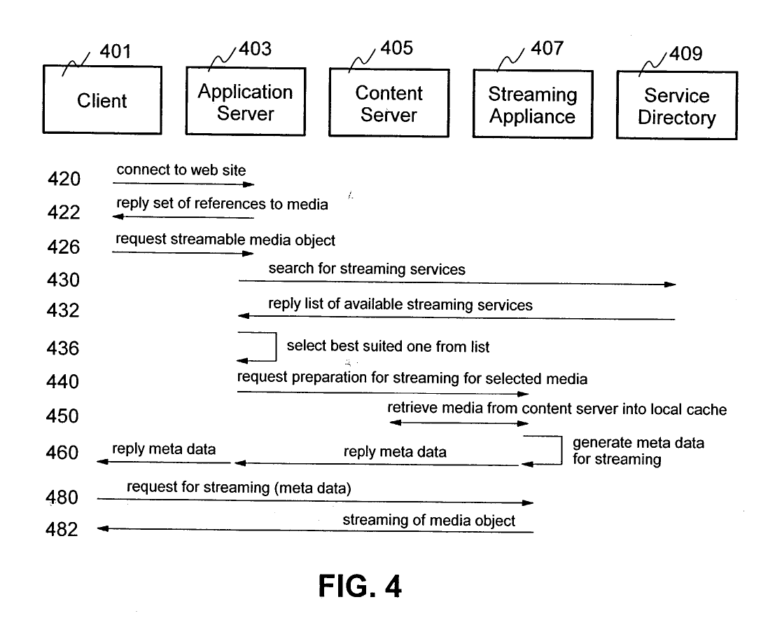

The working method of a streaming network based on appliances is explained using two typical scenarios. FIG. 3 illustrates the method of adding a new streaming appliance to the system. FIG. 4 illustrates the work flow of a scenario where a client is requesting a streamable media object.

If a new streaming appliance 307 is added to the system, the only necessary information it needs is the address of the service directory 309, such as a private UDDI directory. The streaming appliance 307 is already pre-configured to start up and provide streaming service with a default configuration (arrow 320). After starting all defined software and services, the streaming appliance 307 registers itself into the service directory 309 with a description of its services (arrow 322). The registration information contains information such as address of the service, interface description, quality of service properties etc.

An application running on the application server 303 is now able to find these new added appliance during a regular query against the service directory 309 (arrow 330). The service directory 309 will return the respective service description in response to the initial query (arrow 332).

Based on the service description, the application can decide to customize the streaming appliance 307 to solve any specific needs. The customization may be performed through a system administration Web service interface of the streaming appliance as explained with reference to FIG. 2 (arrow 340). As a result of this customization, the streaming appliance itself may update its service description in the service directory (arrow 342).

For systems with a more centralized system administration approach, an alternative method for customization may be applicable. After first power on, the streaming appliance 307 searches the service directory 309 for a customization service and registers itself with this service. The customization service may be part of a complex system administration application, which will handle all configuration tasks. After customizing the streaming appliance through the system administration Web service, the streaming appliance 307 again registers its services with the appropriate description in the service directory 309, to be used for later streaming requests.

After the services of the streaming appliance 307 are registered in the service directory 309, the services may be used as part of the main operation scenario, where a client is requesting a streamable media object as in the following described with reference to FIG. 4. In order to illustrate which functional units are communicating with each other, the respective functional units are depicted in the upper part of FIG. 4, namely, a client 401, an application server 403, a content server 405, a streaming appliance 407 and a service directory 409. All those components correspond to the components of the same name as described with reference to FIG. 1. This scenario starts with the connection of a client to the application server (arrow 420).

Depending on the application which is running on the application server, there may be various iterations, but finally the application server returns a set of references to streamable media objects (arrow 421).

From this set, the client selects a media object and sends the request for streaming to the application server (arrow 426).

The application server searches the service directory, such as an UDDI directory, for available streaming services, optionally with limiting of the search by certain criteria regarding capabilities and/or service quality properties (arrow 430).

On reply, the application server gets a list of available services, including their capability details (arrow 432).

The application server selects the most appropriate service from the list, according to the needed properties (arrow 436). This may be done according to the required streamer type, information about the workload of a selected service, the cache content of that streaming service, etc. The selection is done by two steps. In step 1 the appropriate ones are selected from those listed in the service repository. In step 2, the best-suited one is selected from those by e.g. querying the appliance for actual status data such as workload.

The application server sends the streaming request to the selected streaming appliance Web service, together with the information about the location of the media object (the URL of the object on the content server), and any other data, such as access information and digital rights management related information, etc. (arrow 440).

The streaming appliance retrieves the required rich media object from the content server using i.e. standard file transfer mechanisms (arrow 450). The rich media object will be stored in the local file system of the appliance. Therefore, for any successive request for the same rich media object, it's not necessary to retrieve the data again. The streaming appliance actually acts as a cache.

This step is performed asynchronously, i.e. the calling application does not have to wait until the media data has been fully retrieved. The next step is started as soon as enough data is retrieved to continue.

The streaming service generates the metadata which is needed by the client to initiate streaming and returns the data to the calling application server, which in turn transfers the metadata without any changes to the requesting client (arrow 460).

Using the metadata, the client starts the appropriate player and connects to the stream server of the appliance as listed in the metadata (arrow 480).

After the connection is established, the media object is streamed to the client (arrow 482).

The scenario above describes the usage of the streaming appliance's Web service in a classical Web application. Furthermore it may be used as a building block for any distributed application.

The application can dynamically, at use time, select a certain service from the ones listed in a service directory such as the UDDI according to the requirements of a certain streaming request. The application may use different service providers, depending on the level of service which is needed for this request and is supported by the various providers.

Besides the streaming functionality the streaming appliance supports administrative services. These include configuration, customization, and services to query system properties, as well as services for accounting.

Among the configuration and customization services the operator of the appliance can define general properties such as cache behavior. The streaming appliance will autonomously manage the content of its media cache and therefore needs default settings for e.g. resting time of media within the cache.

The streaming appliance further makes available services to query the above configuration and customization properties. In addition standard system properties such as current workload or cache utilization can be polled via these services.

As the operator of the appliance may want to sell its service (e.g. if provided outside a corporate intranet) the streaming appliance provides services for accounting. This includes customization of communication channels for metering events. As the actual streaming is performed between the streaming appliance and the client, the Web application using the streaming appliance's Web service doesn't even know whether streaming took place or not. If the client keeps the metadata, streaming of the content could be done even several times. For billing purposes the streaming appliance generates metering events which can be polled through the accounting services interface.

Based on the functionality of the streaming appliance, a streaming infrastructure as depicted in the general block diagram in FIG. 4 can be implemented. FIG. 4 shows the system 500 with the following components, all connected via a network 590.

In a back end 510 there is an application server 511 and a content server 512. The whole streaming is handled by the components in block 520, namely, a streaming broker Web service 560, several streaming appliances 521, 522, 523, and a private service directory 565. Finally within the system 500 there is a public service directory 540 and a client 550.

In this system the streaming broker Web service 560 acts as the interface for any application running on the application server 511. In this system the application which requests streaming does not need to select from a list of available streaming appliances. Instead, it just sends the request to the streaming broker Web service 560, which itself selects from its known streaming appliances 521 to 523. To get the list of available streaming appliances the streaming broker Web service 560 uses a private service directory 565. The selection of a certain streaming appliance is done according various properties, such as the streamer capabilities, cache content, workload, etc.

To improve the streaming performance, the application may even select among several streaming broker Web services. Therefore it queries a list of available streaming broker Web services from a public service directory 540, and selects the most appropriate one according certain service properties such as capabilities, defined service qualities, etc.

The present invention can be realized in hardware, software, or a combination of hardware and software. Any kind of computer system or other apparatus adapted for carrying out the methods described herein is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A device for delivering information through a distributed information system to an external client unit in response to a request from an external server unit, the device comprising:
a first interface for configuring and administering said device; and
a device control unit for controlling said device, whereby said device control unit is configured to automatically register a service of said device with an external service directory via said first interface.

2. The device according to claim 1, further comprising:
one or more data servers for delivering requested information;
a second interface for communicating with said external server unit; and
a third interface for communicating with said external client unit, whereby said device control unit is configured to receive a request from said external server unit via said second interface to arrange information delivery to an external client via said third interface.

3. The device according to claim 2, wherein said device control unit further controls said one or more data servers and provides a common interface.

4. The device according to claim 1, further comprising a storage device for storing all information which is necessary for operation and administration.

5. The device according to claim 2, wherein said one or more data servers are formed by one or more stream servers that may work according to different streaming standards.

6. The device according to claim 1, wherein said first interface is configured to make available services to query configuration and/or system properties, such as current work load and/or cache utilization.

7. The device according to claim 1, wherein said first interface is formed by a Web service interface for performing system administration tasks.

8. The device according to claim 2, wherein said second interface is formed by a Web service interface for delivering of information.

9. The device according to claim 2, wherein said third interface is formed by a streaming interface.

10. The device according to claim 2, wherein said second interface is further configured to prepare said device for streaming of requested information and to provide all necessary data to said external server unit in order to deliver information.

11. The device according to claim 2, wherein said third interface is further configured to accept requests from the external client unit for delivering of information.

12. The device according to claim 1, wherein said information is delivered using streaming technology.

13. The device according to claim 2, wherein said first interface and said second interface are defined according to a Service Oriented Architecture (SOA) model standard.

14. A method of operating a device for delivering information through a distributed information system to an external client unit in response to a request from an external server unit, the method comprising the following steps:
establishing a communication connection to an external service directory via a first interface; and
registering a service offered by said device with said external service directory.

15. The method according to claim 14, wherein the steps of establishing a communication connection to an external service directory via a first interface and registering a service offered by said device with said external service directory are performed automatically.

16. The method according to claim 14, wherein said step of registering a service offered by said device with said external service directory includes the step of:
transmitting registration information containing one or more pieces of information from the group consisting of address of the service, interface description and quality of service properties.

17. The method according to claim 14, further comprising the steps of:
receiving from said external server unit a request to prepare delivering of specified information;
retrieving at least a portion of said specified information;
receiving from said external client unit a request for said specified information; and
delivering at least a portion of the retrieved information to said external client unit.

18. The method according to claim 14, further comprising the step of:
after retrieving at least a portion of said specified information, generating metadata to be used by said external client unit to request said specified information and sending said metadata to said external server unit to be forwarded to said external client unit.

19. The method according to claim 14, wherein said step of registering a service offered by said device with said external service directory includes the steps of:
searching the service directory for a customization service; and
registering with that service, whereby said customization service may be part of a complex system administration application which will handle all configuration tasks.

20. A computer program product stored on a computer usable medium, comprising computer readable program means for causing a computer to perform a method according to claim 14.
